(19) United States
(12) Patent Application Publication
(10) Pub. No.: US 2023/0013799 A1
(43) Pub. Date: Jan. 19, 2023

(54) SYSTEMS AND METHODS FOR TRACKING CONSUMER SPEND BEHAVIORS

(71) Applicant: WORLDPAY, LLC, Symmes Township, OH (US)

(72) Inventors: Scott Wayne DeAngelo, Mason, OH (US); Dennis A. Kettler, Lebanon, OH (US); Jacob Matthew Sterling, Creve Coeur, MO (US)

(21) Appl. No.: 17/935,586

(22) Filed: Sep. 27, 2022

Related U.S. Application Data
(63) Continuation of application No. 14/989,863, filed on Jan. 7, 2016.

(51) Int. Cl. G06Q 30/02

(52) U.S. Cl. CPC G06Q 30/0205

(57) ABSTRACT

Technologies for determining spending behavior of a consumer in a category of interest are disclosed. The spending behavior is based on tracking payment vehicle transactions across a number of merchants. Temporal and geographic parameters are considered to determine if a payment vehicle transaction falls within the category of interest. Based on the payment vehicle transactions and the temporal and geographic parameters, Share of Wallet (SOW) can be determined.

### CROSS-REFERENCE TO RELATED APPLICATION(S)

This patent application is a continuation of and claims the benefit of priority to U.S. Nonprovisional patent application Ser. No. 14/989,863, filed on Jan. 7, 2016, the entirety of which is incorporated herein by reference.

### BACKGROUND

Accurately estimating a consumer's spend capacity can allow a financial institution (such as a credit company, lender, transaction processor, etc.) or another consumer services company (such as retail establishment, food/beverage establishments, marketing firm, etc.) to better target potential prospects and identify any opportunities to increase consumer transaction volumes. Consequently, a consumer model that can accurately estimate purchasing power is of paramount interest to many financial institutions and other consumer services companies.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts an example system for tracking consumer spend for share of wallet modeling in connection with various spend categories is schematically depicted;

FIG. 2 depicts an example system that utilizes an expenditure tracking server to track consumer spend for share of wallet modeling in connection with various with product-specific data;

FIG. 3 depicts an example system that utilizes an expenditure tracking server to track consumer spend for share of wallet modeling in connection with groupings of consumers;

FIG. 4 depicts a block diagram of an example expenditure tracking system;

FIGS. 5-6 schematically depict a geographical areas within which a plurality of merchants are located and which an expenditure tracking server can be used to collect and process geospatial and temporal based transaction data; and

FIG. 7 depicts a chart that plots transaction revenue for example merchant categories across a particular time frame based on data collected and processed by an expenditure tracking server in accordance with the present disclosure.

### DETAILED DESCRIPTION

Various non-limiting embodiments of the present disclosure will now be described to provide an overall understanding of the principles of the structure, function, and use of the systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

For simplicity, the description that follows will be provided by reference to a “payment vehicle” or a “payment card,” which generally refers to any type of financial alternative to currency. As is to be clear to those skilled in the art, no aspect of the present disclosure is specifically limited to a specific type of payment vehicle or payment card. Therefore, it is intended that the following description encompasses the use of the present disclosure with many other forms of financial alternatives to currency, including credit cards, debit cards, smart cards, single-use cards, pre-paid cards, electronic currency (such as might be provided through a cellular telephone or personal digital assistant), and the like. Payment vehicles or payment card can be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument.

In accordance with the present disclosure, share of wallet (“SOW”) is a consumer modeling approach that generally refers to the amount of the consumer's total spending that a business or group of businesses capture in the products and services that are offered. Based on the SOW, outputs from the model can describe consumers' spending capability or other behaviors. The outputs from the modeling can be used to support decisions involving marketing, customer management, among other functions or processes. As provided in more detail below, the SOW modeling in accordance with the present disclosure can include geographical and/or temporal elements or parameters to provide insightful analytics into consumer spend patterns and behaviors. Various actions or directives can be developed in response to the identified spend patterns and behaviors. The consumer spend patterns and behaviors can based on data collected and processed by an expenditure tracking server that generally monitors consumers' payment vehicle purchase activity across a plurality of merchants and/or a plurality of payment vehicles. In some embodiments, the expenditure tracking server is a component of, or otherwise affiliated with, an acquirer computing system. As is known the art, acquirer computing systems generally handle the processing and routing of payment vehicle transactions originating at merchant point of sale systems. In this regard, an expenditure tracking server associated with an acquirer computing system potentially has visibility into millions of payment vehicle transactions.

In some embodiments, consumer spend behavior can be tracked in accordance with various categories or groupings. For example, in one embodiment geographical parameters, such as proximity to a particular location or venue, or a particular metropolitan statistical area (MSA), can be used to categorize the data. Additionally or alternatively, the consumer spend behavior can also be tracked based on temporal-based categories or parameters, such as during particular times of day, particular days of the week, or before and after certain events or occurrences. Additionally or alternatively, the consumer spend behavior can also be grouped based merchant-type or product-related information (such as SKU data, etc.). The consumer data can be based on individual consumers, groupings of consumers (such a families, households, etc.), or larger groups of consumer segments which share one or more similar characteristics. As such, due to the wide range of categories and parameters that can be used to process the consumer spend behavior, the SOW determination can provide analytics useful for a wide range of recipients to drive marketing efforts, customer interaction, or even city planning and/or real estate development. Thus, SOW modeling using an expenditure tracking server in accordance with the present disclosure can be used for decisioning on a micro level (i.e., a merchant level) and/or decisioning on a larger or macro level (i.e., a MSA).

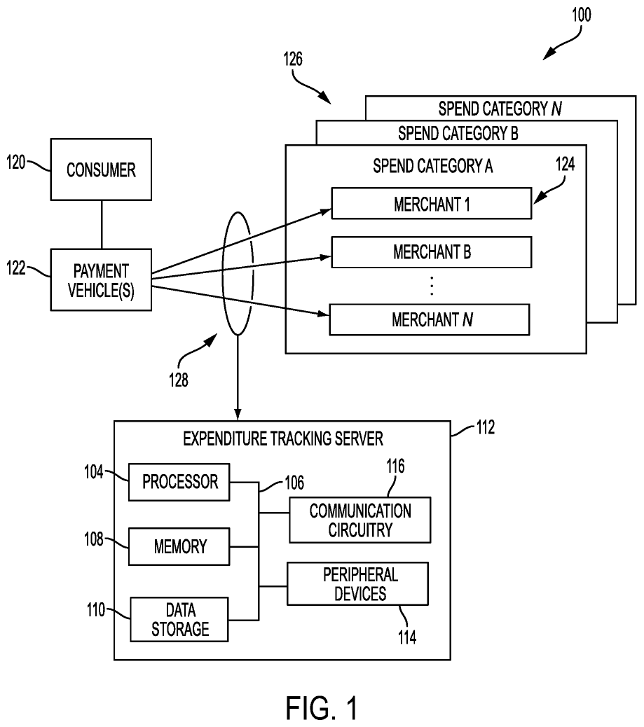

Referring now to FIG. 1, an example system 100 for tracking consumer spend for share of wallet modeling in connection with various spend categories is schematically depicted. A consumer 120 can utilize one or more payment vehicles 122 for purchase transactions at merchants A, B . . . N, generally referred to as merchants 124. The merchants 124 can be any type of service provider, retailer, etc., including brick-and-mortar and/or online merchants, which accepts payment from the consumer 120. The consumer 120 can utilize the payment vehicles 122 through interaction with conventional Point of Sale (POS) devices or point of interaction systems of the various merchants 124. As will be discussed in more detail below, the merchants 124 can be grouped into one or more categories 126, schematically illustrated as categories A, B. N. The categories 126 can be based on, for example, merchant-type, merchant-location, and/or other suitable categories based on various segmentations or groupings that provide useful datasets. The categories 126 can also be temporally limited or defined. For example, only transactions occurring with a particular timeframe and within a particular geographic boundary and/or at particular merchant types can be tracked for analysis.

As indicated by transaction mining 128, an expenditure tracking server 112 can track the transactions initiated at the merchants 124 that utilize the payment vehicles 122. The transaction mining 128 by the expenditure tracking server 112 can collect (in real-time, in batch processing subsequent to transaction activities, or using other data collection processes) a variety of transaction related information as may be available in conventional authorization request messaging protocols, such as transaction amount, merchant category code (MCC), payment vehicle identifier, bank identification number (BIN), time stamp, date stamp, merchant identifier (MID), and so forth. The authorization request may also include a geographical identifier, or include data that can be used by the expenditure tracking server 112 to determine a geographic location of the merchant 124. Alternatively, geographic data regarding the merchant 124 can be provided to the expenditure tracking server 112 separately from the authorization request, either by the merchant 124 or other party. In some embodiments, the transaction mining 128 includes all, or substantially all, of the transactions between a consumer 120 and merchants 124 within a particular category 126, while in other embodiments the transaction mining 128 includes a subset of all the transactions between a consumer 120 and a particular category 126. For instance, the expenditure tracking server 112 might not have access to transactional information for all of the merchants 124 in a particular category 126. From the transaction mining that does occur for the merchants 124 within the purview of the expenditure tracking server 112, the expenditure tracking server 112 can extrapolate information regarding the non-mined transactions.

In some embodiments, during transaction mining 128 the expenditure tracking server 112 determines if the transaction falls within one of the spend categories 126. The determination can be based on any number of factors, such as the geographical location of the merchant 124, the time at which the transaction is being processed, the type of payment vehicle 122 being used for the transaction, the identity of the consumer 120, and so forth. As is to be appreciated, certain transactions that are mined may serve as data points for a plurality of different categories 126, depending on the scope and parameters of the categories 126.

In accordance with various embodiments, the expenditure tracking server 112 can provide various analytics based on the transaction mining 128. By way of non-limiting examples, the percentage of spend at a certain merchant 124 or collection of merchants 124 in a particular category 126 can be determined. The percentage of spend can be based on a particular consumer 120, a grouping of consumers 120, segments of consumers 120, and the like. In the context of grocery stores, for example, the amount of expenditure at a first grocery store (i.e., merchant A) can be compared to the amount of expenditure across an entire grocery category 126. As such, the expenditure tracking server 112 can identify a percentage of a consumer's 120 spend at the first grocery store compared to an aggregate spend. In some embodiments, the consumer data can be segmentized and/or anonymized prior to data processing. By way of another non-limiting example, the amount of spend within a certain geographical area and over a certain period of time can be can be determined by the expenditure tracking server 112.

The expenditure tracking server 112 can be embodied as any type of computing device or server or capable of processing, communicating, storing, maintaining, and transferring data. For example, the expenditure tracking server 112 can be embodied as a microcomputer, a minicomputer, a mainframe, a desktop computer, a laptop computer, a mobile computing device, a handheld computer, a smart phone, a tablet computer, a personal digital assistant, a telephony device, a custom chip, an embedded processing device, or other computing device and/or suitable programmable device. In some embodiments, the expenditure tracking server 112 can be embodied as a computing device integrated with other systems or subsystems, such as those of an acquirer computing system, a financial transaction processing gateway, and/or other entities that function to assist with the processing of financial transactions within a payment ecosystem. In the illustrative embodiment of FIG. 1, the expenditure tracking server 112 includes a processor 104, a system bus 106, a memory 108, a data storage 110, communication circuitry 116, and one or more peripheral devices 114. Of course, the expenditure tracking server 112 can include other or additional components, such as those commonly found in a server and/or computer (e.g., various input/output devices), in other embodiments. Additionally, in some embodiments, one or more of the illustrative components can be incorporated in, or otherwise from a portion of, another component. For example, the memory 108, or portions thereof, can be incorporated in the processor 104 in some embodiments. Furthermore, it should be appreciated that the expenditure tracking server 112 can include other components, sub-components, and devices commonly found in a computer and/or computing device, which are not illustrated in FIG. 1 for clarity of the description.

The processor 104 can be embodied as any type of processor capable of performing the functions described herein. For example, the processor 104 can be embodied as a single or multi-core processor, a digital signal processor, microcontroller, a general purpose central processing unit (CPU), a reduced instruction set computer (RISC) processor, a processor having a pipeline, a complex instruction set computer (CISC) processor, an application specific integrated circuit (ASIC), a programmable logic device (PLD), a field programmable gate array (FPGA), or other processor or processing/controlling circuit or controller.

In various configurations, the expenditure tracking server 112 includes a system bus 106 for interconnecting the various components of the expenditure tracking server 112. The system bus 106 can be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations with the processor 104, the memory 108, and other components of the expenditure tracking server 112. In some embodiments, the expenditure tracking server 112 can be integrated into one or more chips such as a programmable logic device or an application specific integrated circuit (ASIC). In such embodiments, the system bus 106 can form a portion of a system-on-a-chip (SoC) and be incorporated, along with the processor 104, the memory 108, and other components of the expenditure tracking server 112, on a single integrated circuit chip.

The memory 108 can be embodied as any type of volatile or non-volatile memory or data storage capable of performing the functions described herein. For example, the memory 108 can be embodied as read only memory (ROM), random access memory (RAM), cache memory associated with the processor 104, or other memories such as dynamic RAM (DRAM), static RAM (SRAM), programmable ROM (PROM), electrically erasable PROM (EEPROM), flash memory, a removable memory card or disk, a solid state drive, and so forth. In operation, the memory 108 can store various data and software used during operation of the expenditure tracking server 112 such as operating systems, applications, programs, libraries, and drivers.

The data storage 110 can be embodied as any type of device or devices configured for short-term or long-term storage of data such as, for example, memory devices and circuits, memory cards, hard disk drives, solid-state drives, or other data storage devices. For example, in some embodiments, the data storage 110 includes storage media such as a storage device that can be configured to have multiple modules, such as magnetic disk drives, floppy drives, tape drives, hard drives, optical drives and media, magneto-optical drives and media, Compact Disc (CD) drives, Compact Disc Read Only Memory (CD-ROM), Compact Disc Recordable (CD-R), Compact Disc Rewriteable (CD-RW), a suitable type of Digital Versatile Disc (DVD) or Blu-Ray disc, and so forth. Storage media such as flash drives, solid state hard drives, redundant array of individual disks (RAID), virtual drives, networked drives and other memory means including storage media on the processor 104, or the memory 108 are also contemplated as storage devices. It should be appreciated that such memory can be internal or external with respect to operation of the disclosed embodiments. It should also be appreciated that certain portions of the processes described herein can be performed using instructions stored on a computer-readable medium or media that direct or otherwise instruct a computer system to perform the process steps. Non-transitory computer-readable media, as used herein, comprises all computer-readable media except for transitory, propagating signals.

The communication circuitry 116 of the expenditure tracking server 112 may be embodied as any type of communication circuit, device, interface, or collection thereof, capable of enabling communications between the expenditure tracking server 112 and computing devices communicatively coupled thereto. For example, the communication circuitry 116 may be embodied as one or more network interface controllers (NICs), in some embodiments. The communication circuitry 116 may be configured to use any one or more communication technologies (e.g., wireless or wired communications) and associated protocols (e.g., Ethernet, Wi-Fi®, WiMAX, etc.) to effect such communication. The expenditure tracking server 112 can communicate over one or more networks. The network(s) can be embodied as any number of various wired and/or wireless communication networks. For example, the network(s) can be embodied as or otherwise include a local area network (LAN), a wide area network (WAN), a cellular network, or a publicly-accessible, global network such as the Internet. Additionally, the network(s) can include any number of additional devices to facilitate communication with the computing devices of the system 100.

Additionally, in some embodiments, the expenditure tracking server 112 can further include one or more peripheral devices 114. Such peripheral devices 114 can include any type of peripheral device commonly found in a computing device such as additional data storage, speakers, a hardware keyboard, a keypad, a gesture or graphical input device, a motion input device, a touchscreen interface, one or more displays, an audio unit, a voice recognition unit, a vibratory device, a computer mouse, a peripheral communication device, and any other suitable user interface, input/output device, and/or other peripheral device.

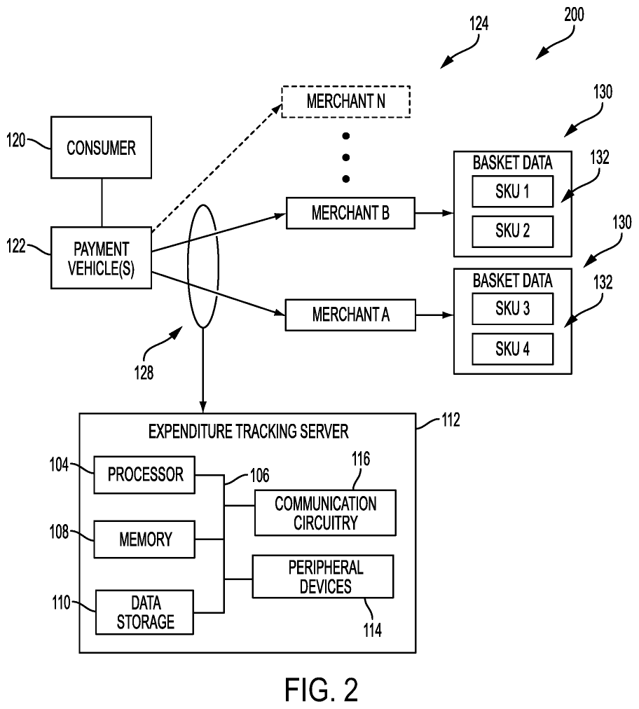

Referring now to FIG. 2, an example system 200 is depicted that utilizes the expenditure tracking server 112 to track consumer spend for share of wallet modeling in connection with various with product-specific data, shown as basket data 130. The basket data 130 can vary based on transaction type. In the illustrated embodiment, the basket data 130 comprises stock keeping unit (SKU) 1, 2, 3 and 4, generally referred to as SKU data 132. The transaction mining 128 performed by the expenditure tracking server 112 can include collecting the basket data 130 thereby allowing additional analytics to be performed. The basket data 130 can be provided to the expenditure tracking server 112 by the POS system of the merchant 124, an inventory control system of the merchant 124, or any other suitable data source using suitable data transfer techniques. As schematically illustrated in FIG. 2, the expenditure tracking server 112 might be able to receive transaction data (and/or basket data 130) from only certain merchants 124, shown as Merchant A and Merchant B, and not from Merchant N. Merchant A and Merchant B can have specialized communications or interface to facilitate the transfer of the basket data 130 to the expenditure tracking server 112, for example. In one embodiment, an application programming interfaces (API) is used to by the expenditure tracking server 112 to request basket data 130 from Merchant A and Merchant B which is used in the SOW modeling performed by the expenditure tracking server 112.

Utilizing basket data 130 can allow the SOW modeling of the expenditure tracking server 112 to provide finer granularity and insight into consumer behavior and trends. For example, based on the transaction mining 128 it may be determined that Merchant A enjoys a large wallet share of a particular consumer or segment when examining at total spend across a category 126. However, when analyzing particular SKUs or classes of SKUs (such as cosmetics, organic vegetables, etc.) Merchant B enjoys a much larger wallet share than Merchant A. Based on this data, Merchant A can seek to modify consumer behavior through targeted offers, or other types of activities or drivers. In some embodiments, the expenditure tracking server 112 can provide recommendations to one or more of the merchants 124 based on the processing of the data collected for the merchants 124.

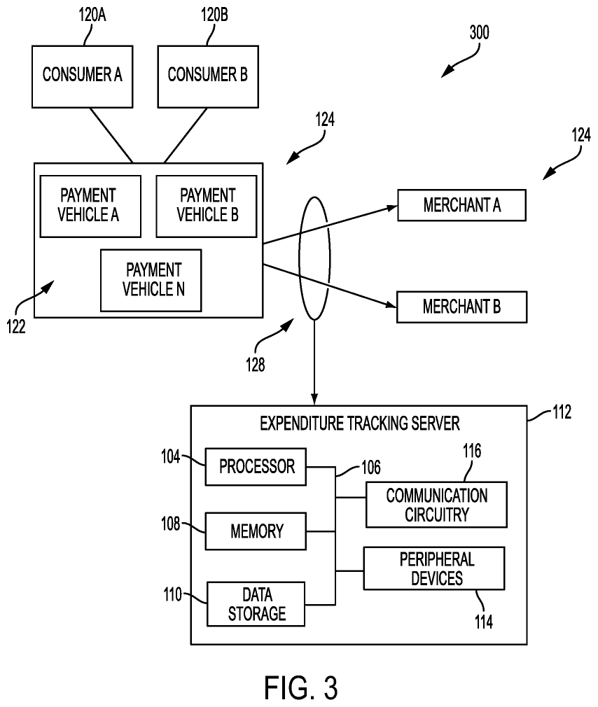

Referring now to FIG. 3, as part of the data collection techniques utilized by the expenditure tracking server 112 and in an effort to gather and process usable market data, certain consumers can be grouped together and/or certain payment vehicles can be grouped together. In some embodiments, such grouping may generally be referred to as householding. As shown in FIG. 3, for example, transactions initiated by either consumer 120A or consumer 1208 using any of a grouping of payment vehicles 124 can be identified by the expenditure tracking server 112 as being associated with the same household or other type of consumer spending unit. In some embodiments, all of the payment vehicles 122 that are issued to consumers having the same mailing address, irrespective of cardholder name, are identified as being in the same grouping of payment vehicles 124. In other embodiments, all of the payment vehicles 122 that are issued to consumers having the same mailing address and that share the same last name are identified as being in the same grouping of payment vehicles 124. In any event, by grouping consumers 120A, 1208 and/or payment vehicles 122, the consumer behavior identification and transaction tracking performed by the expenditure tracking server 112 can be expanded to attribute certain transactional behavior to a household (or segments of households), as opposed to a single consumer, thereby providing further insight into spending patterns.

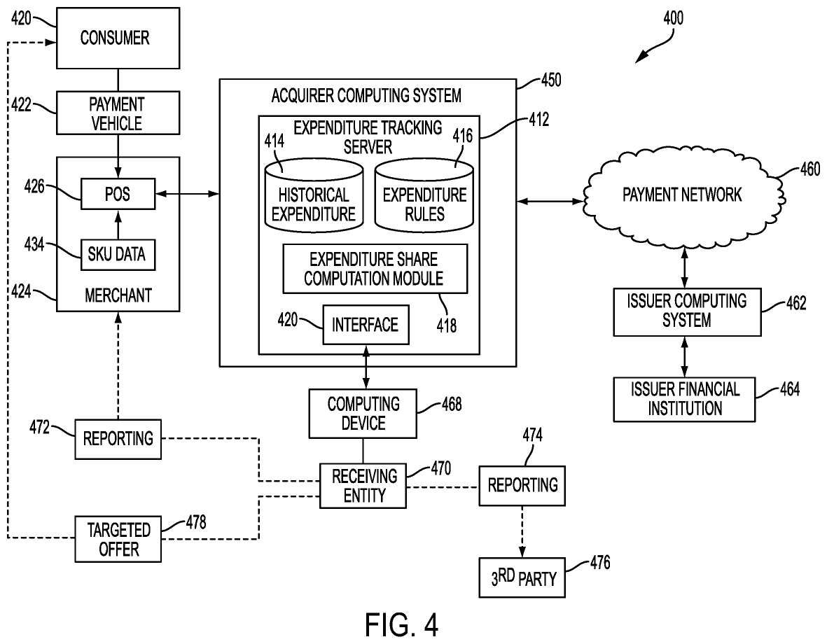

FIG. 4 depicts a block diagram of an example expenditure tracking system 400. In the illustrated embodiment, an expenditure tracking server 412 is hosted by, or otherwise a component of or affiliated with an acquirer computing system 450. The acquirer computing system 450 is configured to communicate with point of sale (POS) systems 426 and communicate with one or more payment networks 460 and issuer computing systems 462. For convenience, only one POS system 426 and one issuer computing system 462 is shown. Moreover, as used herein, the term POS system is used broadly to include POS system 426 or point of interaction system at brick and mortar locations and “virtual” POS system that can be associated with an online retailor or “in-app” purchases. In some cases, the POS system includes a terminal, or other network computing system, which may be used to facilitate a payment transaction at a merchant location. The POS system 426 is affiliated with a merchant 424. The term merchant, as used herein, refers generally to any type of retailer, service provider, or any other type of business that is in networked communication with the acquirer computing system 450 and uses the payment processing services of the acquirer computing system 450. Payment processing services can include receiving and responding to authorization requests as well as facilitating the settlement of funds associated with card-based transactions occurring at the merchant 424.

In accordance with some embodiments, POS system 426 can generally facilitate the transmission of transaction-related information to the acquirer computing system 426, as is known in the art. The transaction-related information can comprise an authorization request as well as other types of identifying indicia. The identifying indicia can vary based on POS system 426, the type of merchant and the type of transaction, but example types of identifying indicia can include any of the following: a merchant identification (MID) identifier, a loyalty program identifier, a bank identification (BIN) identifier; a merchant category code (MCC) identifier; a media access control (MAC) identifier; an internet protocol (IP) identifier; a geographic identifier; a payment type identifier; and/or a consumer name or other consumer identifier. In some embodiments, the information provided to the acquirer computing system 450 and/or the expenditure tracking server 412 can include SKU data 434. A consumer 420, sometimes referred to as a cardholder or card member, can provide information from a payment vehicle 422 to the POS system 426 to initiate a transaction with the merchant 424.

In accordance with the present disclosure, the expenditure tracking server 412 of acquirer computing system 450 can provide an expenditure interface 420 that is accessible by a receiving entity 470 through a computing device 468. The particular implementation of the expenditure interface 420 can vary, but in some example embodiments, the expenditure interface 420 is a web portal that allows a receiving entity 470 to input category parameters, review SOW analytics, select predesigned expenditure parameters, and so forth. In some embodiments, the expenditure interface 420 is provided by a specialized application that is executed on the computing device 468. The receiving entity 470 can be associated with, for example, the merchant 424, the issuer financial institution 464, or any other third party, such as a marketing entity. The data regarding the expenditure tracked by the expenditure tracking server 412 can be stored in one or more historical expenditure databases 414. Rules or parameters regarding categories, householding, or other analytical frameworks can be stored in one or more expenditure rules database 416.

Referring still to the acquirer computing system 450, an authorization request can be received from the POS system 426. The authorization request can comprises various data, including, for example, a MID, a MCC, an account identifier, and a transaction amount. Once the authorization request is received, an expenditure share computation module 418 can determine if the expenditure tracking server 412 should log certain information relevant to the transaction for SOW processing. The determination can be based on any number of factors, inputs, or parameters, such as whether the transaction and/or the consumer 420 fall within a particular category (i.e., a category 126) or grouping under review. In one example, it is determined if the consumer 420 and the merchant 424 are within a segment definition of a SOW model.

Subsequent to receiving a plurality of transactions from the merchant 424 and/or other merchants, the expenditure share computation module 418 can process the information collected from the transactions. The processed information can be presented to any suitable parties, depicted as receiving entity 470. In one embodiment, the SOW model is utilized to provide reporting 474 to the merchant 424 and/or reporting 474 for other parties (shown as 3rd party 476). In one embodiment, the SOW model is utilized to develop or otherwise identify a targeted offer 478 to provide to the consumer 420. Such targeted offer 478 may be aimed to incentivize certain future behaviors based on the historical expenditure of the consumer 420. By way of example, the targeted offer 478 may be a coupon or discount for use at the merchant 424, or a coupon or discount for use at the merchant 424 for a particular type or class of goods. In some embodiments, the targeted offer 478 can be dispatched in an automated fashion based on the outcome of the SOW analysis.

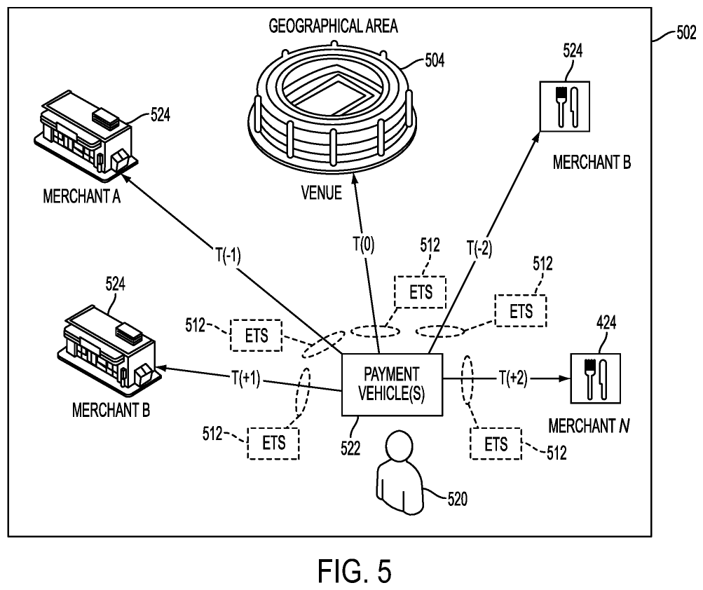

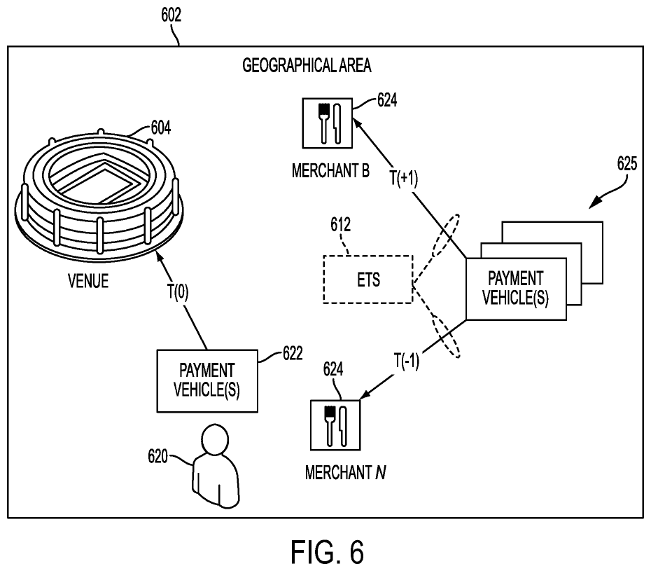

Referring now to FIGS. 5-6, an expenditure tracking server 512 in accordance with the presented disclosure can be used to collect and process geospatial and temporal based transaction data to provide particular insights into consumer spending behaviors. FIG. 5 schematically depicts a geographical area 502 within which a plurality of merchants 524 are located. The plurality of merchants 524 are physically proximate to a venue 504, such as a sporting complex (i.e., football stadium, baseball stadium, etc.) or other type of entertainment venue (i.e., concert hall, arena, amphitheater, etc.) or point of interest. An operator of the venue 504, or other interested party, can utilize transactional data collected by an expenditure tracking server 512 to gain insight into consumer spend behavior that occurs for a period of time before an event at the venue 504, the period of time during the event at the venue 504, and the period of time after the event at the venue 504. For the purposes of illustration, transactions initiated by a consumer 520 using payment vehicles 522 occurring before an event at the venue 504 are identified as T(−1) and T(−2), transactions occurring during an event at the venue 504 are identified as T(0), and transactions occurring after an event at the venue 504 are identified as T(+1) and T(+2). Using the transactional data collected by the expenditure tracking server 512 from merchants 524 geographically proximate to the venue 504, interested parties can identify spending behaviors or trends. For instance, a venue operator may identify which types of merchants 524 proximate to the venue 504 experience higher transactional volumes before and after an event. Using such information, a venue operator may identify the types of the type of merchant 524 which would likely succeed if they operated within the venue 504. As is to be appreciated, a wide array of operational decisioning could be performed based on the optics to consumer behavior as tracked by the expenditure tracking server 512.

FIG. 6 schematically depicts another example of utilizing an expenditure tracking server 612 in accordance with the presented disclosure to collect and process geospatial and temporal based transaction data to provide particular insights into consumer spending behaviors at a venue 604 and/or merchants 624. A geographical area 602 is depicted within which the venue 604 and merchants 624 are located. In this example, the payment vehicle 622 utilized to initiate transactions with a venue 604 by the consumer 620 is not necessarily the same payment vehicle 622 as the payment vehicle 625 utilized to initiate transactions before an event at the venue 604 (depicted as transactions T(−1)) and transactions occurring after an event at the venue (depicted as transactions T(+1)). Nevertheless, an expenditure tracking server 612 can identify certain types of spending behaviors that may be of interest to an operator of the venue 604, among other interested parties. For instance, the expenditure tracking server 612 may identify an increase in transaction volume at particular types of merchants 624 (i.e., upscale dining) in the hours immediately leading up to an event at the venue 604 and the hours immediately following an event at the venue 604. As such, these spending trends identified by the expenditure tracking server 612 can be utilized to drive decisioning with regarding marketing, resource allocation, and the like.

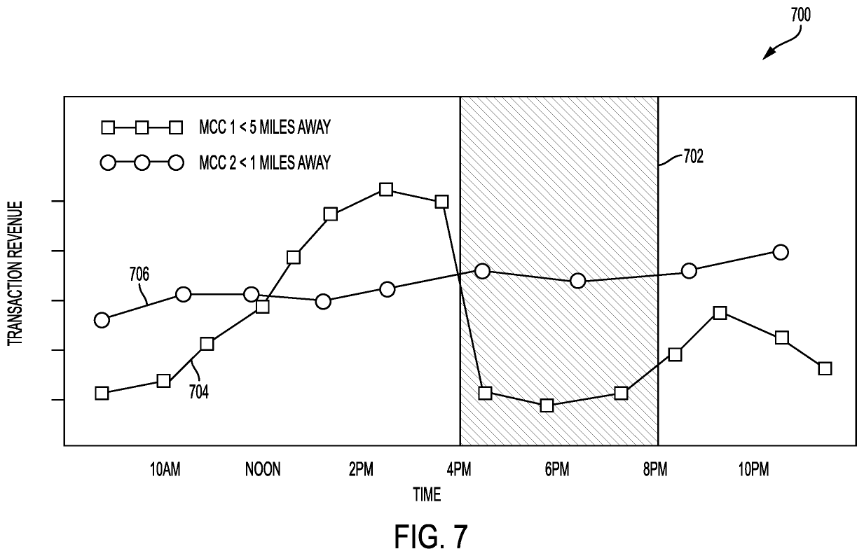

FIG. 7 schematically depicts a chart 700 that plots transaction revenue for example merchant categories across a particular time frame based on data collected and processed by an expenditure tracking server in accordance with the present disclosure. In the illustrated embodiment, the merchant categories are based on a merchant category code (MCC) and are geographically limited, with the data including transactions 704 occurring at merchants of a first category code within 5 miles of a venue and the data including transactions 706 occurring at merchants of a second category code within 1 mile of a venue. In the illustrated embodiment, an event time window 702 is identified, with the event starting at 4 pm and the event ending at 8 pm. In some embodiments, the event time window 702 can be supplied to the expenditure tracking server by the computing device 468 (FIG. 4). The data collected by the expenditure tracking server provides temporal and geographically relevant spend data, with chart 700 indicating that the transaction revenue of MCC 1 is impacted by the event while the transaction revenue of MCC 2 is seemingly not impacted by the event.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A categorized consumer expenditure tracking method, the method comprising:
receiving, at an expenditure tracking server, transactional data obtained from a plurality of merchants associated with an entity;
identifying, using the expenditure tracking server and within the transactional data, consumer spending behavior at a plurality of time points surrounding an event hosted by the entity;
determining, using the expenditure tracking server, one or more trends in the consumer spending behavior at each of the plurality of time points across the plurality of merchants; and
performing an action based on the determined one or more trends in the consumer spending behavior.

2. The method of claim 1, wherein the plurality of time points comprise: a first time window corresponding to a period before the event, a second time window corresponding to a period during the event, and a third time window corresponding to a period after the event.

3. The method of claim 1, wherein the one or more trends correspond to an increase or decrease, at each of the plurality of time points, in transaction volume for at least one of: a merchant category, a merchant location, a product type; and a product location.

4. The method of claim 1, further comprising:
delineating a geographical area surrounding a venue associated with the entity,
identifying which of the plurality of merchants are not contained within the geographical area; and
ignoring the transactional data from each of the plurality of merchants not contained within the geographical area.

5. The method of claim 4, further comprising:
delineating a time window within the plurality of time points;
identifying the transactional data received outside of the time window; and
ignoring the transactional data associated with each of the plurality of merchants contained within the geographical area but received outside of the time window.

6. The method of claim 5, wherein the performing the action comprises generating a share of wallet model that identifies, for each of the plurality of merchants contained within the geographical area and generating the transactional data during the time window, a percentage of consumer spend based on an aggregate consumer spend across all of the plurality of merchants and across all of the plurality of time points.

7. The method of claim 1, wherein the performing the action comprises performing a resource allocation action associated with the one or more merchants.

8. A system for consumer spend tracking, the system comprising:
one or more processors; and
a non-transitory computer readable medium having instructions stored thereon which when executed by at least one of the one or more processors cause the at least one of the one or more processors to perform a method comprising:
receiving, at an expenditure tracking server, transactional data obtained from a plurality of merchants associated with an entity;
identifying, using the expenditure tracking server and within the transactional data, consumer spending behavior at a plurality of time points surrounding an event hosted by the entity;
determining, using the expenditure tracking server, one or more trends in the consumer spending behavior at each of the plurality of time points across the plurality of merchants; and
performing an action based on the determined one or more trends in the consumer spending behavior.

9. The system of claim 8, wherein the plurality of time points comprise: a first time window corresponding to a period before the event, a second time window corresponding to a period during the event, and a third time window corresponding to a period after the event.

10. The system of claim 8, wherein the one or more trends correspond to an increase or decrease, at each of the plurality of time points, in transaction volume for at least one of: a merchant category, a merchant location, a product type; and a product location.

11. The system of claim 8, further comprising:
delineating a geographical area surrounding a venue associated with the entity,
identifying which of the plurality of merchants are not contained within the geographical area; and
ignoring the transactional data from each of the plurality of merchants not contained within the geographical area.

12. The system of claim 11, further comprising:
delineating a time window within the plurality of time points;
identifying the transactional data received outside of the time window; and
ignoring the transactional data associated with each of the plurality of merchants contained within the geographical area but received outside of the time window.

13. The system of claim 12, wherein the performing the action comprises generating a share of wallet model that identifies, for each of the plurality of merchants contained within the geographical area and generating the transactional data during the time window, a percentage of consumer spend based on an aggregate consumer spend across all of the plurality of merchants and across all of the plurality of time points.

14. The system of claim 8, wherein the performing the action comprises performing a resource allocation action associated with the one or more merchants.

15. A non-transitory computer-readable medium for categorized consumer expenditure tracking, the non-transitory computer-readable medium storing instructions which, when executed by one or more processors, cause the one or more processors to perform a method comprising:
receiving, at an expenditure tracking server, transactional data obtained from a plurality of merchants associated with an entity;
identifying, using the expenditure tracking server and within the transactional data, consumer spending behavior at a plurality of time points surrounding an event hosted by the entity;
determining, using the expenditure tracking server, one or more trends in the consumer spending behavior at each of the plurality of time points across the plurality of merchants; and
performing an action based on the determined one or more trends in the consumer spending behavior.

16. The non-transitory computer-readable medium of claim 15, wherein the plurality of time points comprise: a first time window corresponding to a period before the event, a second time window corresponding to a period during the event, and a third time window corresponding to a period after the event.

17. The non-transitory computer-readable medium of claim 15, wherein the one or more trends correspond to an increase or decrease, at each of the plurality of time points, in transaction volume for at least one of: a merchant category, a merchant location, a product type; and a product location.

18. The non-transitory computer-readable medium of claim 15, further comprising:
delineating a geographical area surrounding a venue associated with the entity,
identifying which of the plurality of merchants are not contained within the geographical area; and
ignoring the transactional data from each of the plurality of merchants not contained within the geographical area.

19. The non-transitory computer-readable medium of claim 18, further comprising:
delineating a time window within the plurality of time points;
identifying the transactional data received outside of the time window; and
ignoring the transactional data associated with each of the plurality of merchants contained within the geographical area but received outside of the time window.

20. The non-transitory computer-readable medium of claim 19, wherein the performing the action comprises generating a share of wallet model that identifies, for each of the plurality of merchants contained within the geographical area and generating the transactional data during the time window, a percentage of consumer spend based on an aggregate consumer spend across all of the plurality of merchants and across all of the plurality of time points.
